(19) United States
(12) Patent Application Publication
(10) Pub. No.: US 2021/0071716 A1
(43) Pub. Date: Mar. 11, 2021

(54) BEARING AND METHOD FOR PRODUCING A BEARING

(71) Applicant: Schaeffler Technologies AG & Co. KG, Herzogenaurach (DE)

(72) Inventor: Martin Kram, Gerolzhofen (DE)

(73) Assignee: Schaeffler Technologies AG & Co. KG, Herzogenaurach (DE)

(21) Appl. No.: 16/962,412

(22) PCT Filed: Jan. 18, 2019
(86) PCT No.: PCT/DE2019/100049

§ 371 Date: Jul. 15, 2020

(30) Foreign Application Priority Data
Jan. 24, 2018 (DE) 10 2018 101 508.9

(51) Int. Cl. F16C 41/00; F16C 19/36; F16C 33/46

(52) U.S. Cl. CPC F16C 41/007; F16C 2233/00; F16C 33/46; F16C 19/36

(57) ABSTRACT

A bearing (1), in particular a rolling bearing or plain bearing, has a first bearing component, such as a bearing ring (2, 3) and/or a rolling element cage (5), and a function module (10) for detecting a measured variable and/or for activating state changes and/or for processing information and/or for providing energy, the functional module (10) being arranged completely enclosed within the first bearing component (2, 3, 5). The bearing may be produced by injection molding or 3D printing.

### CROSS-REFERENCE TO RELATED APPLICATIONS

This application is the U.S. National Phase of PCT Appln. No. PCT/DE2019/100049 filed Jan. 18, 2019, which claims priority to DE 10 2018 101 508.9 filed Jan. 24, 2018, the entire disclosures of which are incorporated by reference herein.

### TECHNICAL FIELD

The disclosure relates to a bearing, in particular a rolling bearing or plain bearing, with a first bearing component, in particular a bearing ring and/or a rolling element cage, and a function module for detecting a measured variable and/or for activating changes in state and/or for processing information and/or for providing energy. Furthermore, the disclosure relates to a method for producing such a bearing.

### BACKGROUND

Such bearings with a function module for detecting a measured variable are also referred to as sensor bearings. Sensor bearings designed as rolling bearings are known, for example, under the name FAG VARIOSENSE®. In these rolling bearings, additional sensor rings are provided in the axial direction in addition to the bearing rings, which include one or more sensor modules or a measuring object interacting with the sensor modules. This additional sensor ring increases the mounting space required for the bearing compared to a conventional bearing without a sensor module. It is therefore not always possible to replace a conventional bearing with such a sensor bearing, in particular in those applications in which only a small mounting space is available.

Furthermore, DE 10 2014 204 025 A1 describes a rolling bearing with a bearing ring which has a material recess into which a measuring element is inserted. In this rolling bearing, an undesirable increase in the mounting space by the measuring element can be avoided by arranging the measuring element flush with the outside contour of the bearing ring. However, the measuring element must be pressed into the material recess after the bearing ring has been produced, which involves a certain amount of work. In addition, undesirable damage to the measuring element due to pressurization and/or contamination cannot be ruled out.

### SUMMARY

It is desirable to specify a bearing with a functional module which does not enlarge the mounting space required for the bearing and can be produced with reduced effort, while improving protection against undesired damage to the functional module.

A bearing, in particular a rolling bearing or plain bearing, has a first bearing component and a function module for detecting a measured variable and/or for activating state changes and/or for processing information and/or for providing energy, wherein the functional module is completely enclosed within the first bearing component.

In the bearing, an undesirable increase in the mounting space can be avoided by arranging the functional module to be completely enclosed within the first bearing component. This means that the functional module is completely surrounded by the material of the bearing component. By enclosing the sensor component, it is also better protected against unwanted external influences.

The functional module can be designed, for example, as a sensor module or actuator module or processor module or energy supply module.

The first bearing component is preferably a bearing ring or a rolling element cage.

The bearing can be designed as a linear bearing, in particular a linear rolling bearing or linear slide bearing, or as a rotary bearing, in particular a rotary rolling bearing or a rotary slide bearing. If the functional module is designed as a sensor module, it preferably comprises at least one sensor, for example a speed sensor, a temperature sensor or a vibration sensor. The functional module may have a plurality of sensors, in particular sensors selected from the aforementioned list.

The bearing may have a second bearing component, which particularly is made of plastic, and a measuring object interacting with the functional module is arranged completely enclosed within the second bearing component. This means that the measuring object is completely surrounded by the material of the bearing component. The first bearing component is preferably a first bearing ring of the bearing and the second bearing component is a second bearing ring, so that a relative movement of the two bearing rings can be detected via the functional module. Alternatively or additionally, it can be provided that a further functional module is arranged completely enclosed within the second bearing component, so that measurement variables can be determined both on the first bearing component, for example a first bearing ring, and on the second bearing component, for example a second bearing ring or a rolling bearing cage. The bearing particularly preferably has a third bearing component or further bearing components which are made of plastic and a measuring object interacting with the function module and/or a further function module is arranged completely enclosed within the third or further bearing component.

A preferred design provides that the first bearing component and/or the second bearing component is made of plastic and is produced by a plastic injection molding process. Plastic injection molding offers the advantage that the functional module or the measuring object interacting with the functional module can be introduced into the bearing part when the respective bearing part is being injected, without the need for additional processing steps.

An alternative, preferred design provides that the first bearing component and/or the second bearing component is produced by a 3D printing process. The first bearing component and/or the second bearing component is preferably made of plastic. Alternatively, the first bearing component and/or the second bearing component can be made of metal. Compared to injection molding, 3D printing does not require a tool that is adapted to the shape of the bearing component to be produced. Rather, even small quantities of bearing components can be produced economically, whereby it is possible to integrate the functional module or the measuring object interacting with the functional module into the bearing part when printing the respective bearing part.

A method is also proposed for the production of a bearing, in particular a rolling bearing or plain bearing, with a first bearing component, in particular a bearing ring and/or a rolling body cage, and a functional module for detecting a measured variable and/or for activating state changes and/or for processing information and/or for providing energy, the functional module being arranged in such a way that it is completely enclosed within the bearing component.

The production method results in the same advantages as those already described in connection with the bearing.

The first bearing component is preferably made of plastic. Alternatively, the first bearing component can be made of metal.

According to an advantageous design of the method, it is provided that the bearing has a second bearing component and a measuring object interacting with the functional module and/or a further functional module is arranged in such a way that it is completely enclosed within the second bearing component.

It is further advantageous if the first bearing component and/or the second bearing component are/is made of plastic and is produced by a plastic injection molding process.

In this context, a design in which the functional module and/or the measuring object interacting with the functional module is overmolded has proven to be advantageous so that the insertion of the functional module or measuring object can take place in one step with the manufacture of the bearing component. The functional module or the measurement object can, for example, be inserted into an injection mold and overmolded with the plastic. After the injection molding, the bearing component can be reworked, for example by grinding.

Alternatively, the first bearing component and/or the second bearing component may be produced by means of a 3D printing process. The first bearing component and/or the second bearing component can be printed from plastic or from metal.

In this context, it is advantageous if the first bearing component is printed on the functional module or printed around the functional module so that the functional module can be included in the bearing component when it is printed. As an alternative or in addition, the second bearing component can be printed on the measurement object interacting with the function module or the further function module or printed around it.

Another alternative is to print a first area of the first bearing component with a recess, place the functional module in the recess and then print a second area of the first bearing component on the functional module. Similarly, a first area of the second bearing component can first be printed with a recess, the measuring object or a further function module can be introduced into the recess and then a second area of the second bearing component can be printed on the measuring object or the further function module.

An element of the function module or the measuring object, for example a housing of the function module or measuring object, may be produced by means of a 3D printing process. This element of the function module is particularly preferably printed on or printed around the measuring object interacting with the function module or the function module.

If the bearing has a metal bearing component, it has proven to be advantageous if the functional module or the measuring object is inserted into the bearing component during a forming process. For example, a functional module or measurement object can be introduced into a bearing component, for example a bearing ring, during forging.

In addition to the advantageous configurations described above, the advantageous features and configurations described in connection with the bearing can also be used alone or in combination in the production method.

### BRIEF DESCRIPTION OF THE DRAWINGS

Further details and advantages will be explained below with reference to the exemplary embodiment shown in the drawings. Herein:

FIG. 1 shows a first exemplary embodiment of a bearing in a schematic sectional view;

FIG. 2 shows a second exemplary embodiment of a bearing in a schematic sectional view; and

FIG. 3 shows a further schematic sectional illustration of the bearing from FIG. 2.

### DETAILED DESCRIPTION

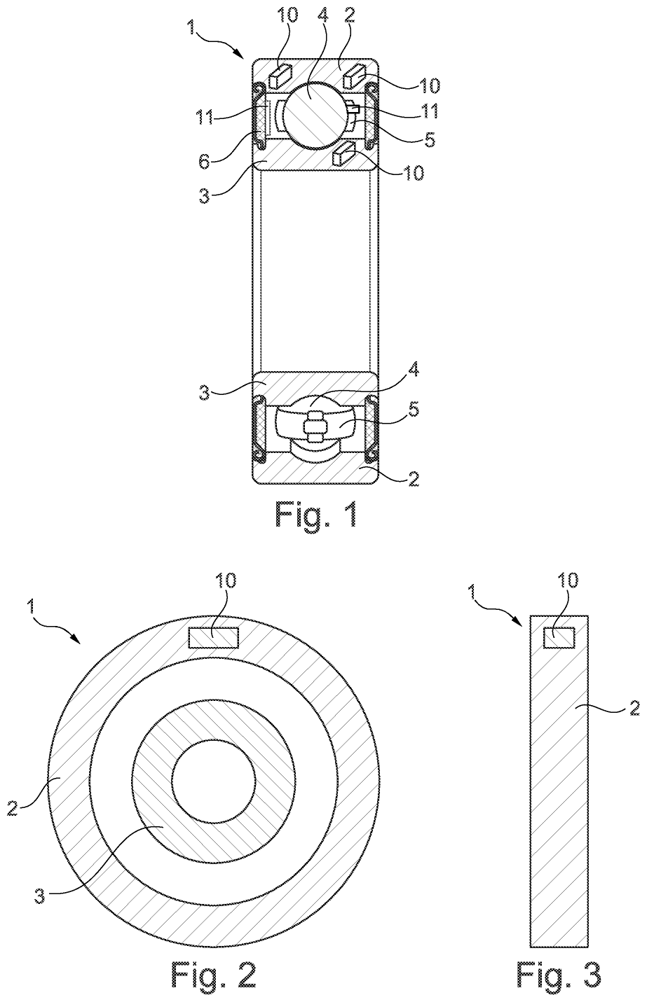

FIG. 1 shows a bearing 1 designed as a rolling bearing. The bearing 1 has as bearing components, among others, an outer bearing ring 2, an inner bearing ring 3 that can rotate relative to the outer bearing ring 2 and rolling elements 4 arranged between the outer bearing ring 2 and the inner bearing ring 3. The rolling elements 4 are arranged in a rolling element cage 5. The interior of the bearing 1, i.e. the space between the outer bearing ring 2 and the inner bearing ring 3 is sealed by means of sealing elements 6, so that a lubricant present in the interior cannot escape unintentionally, but the interior is also not affected by penetrating contaminants.

The bearing 1 has a plurality of function modules 10 designed as sensor modules, each for recording at least one measured variable, and is also referred to as a sensor bearing. These functional modules 10 can have, for example, a sensor for detecting the temperature, vibrations or the rotational speed of the bearing 1. In order not to increase the required mounting space compared to a bearing without sensors, the outer bearing ring 2 and the inner bearing ring 3 are made of a plastic and the functional modules 10 are arranged completely enclosed within the outer bearing ring 2 and the inner bearing ring 3. This also enables economical production of the bearing and improved protection of the functional modules against environmental influences.

A plurality of measurement objects 11 are provided as further components of the bearing 1, which interact with one or more of the function modules 10 in order to detect measurement variables. These measuring objects 11 are also referred to as “target”. A first measuring object 11 is arranged on a sealing element 6 which is connected to the outer bearing ring 2 in a manner fixed against relative rotation. The first measuring object can interact with a function module 10 arranged on the inner bearing ring 3 in order to detect a movement quantity of the movement of the inner bearing ring 3 relative to the outer bearing ring 4, in particular a rotational speed. Furthermore, a second measuring object 11 is arranged on the rolling element cage 5. According to a modification of this exemplary embodiment, one or more of the measurement objects 11 can be arranged completely enclosed within a bearing component, for example within the outer bearing ring 2, the inner bearing ring 3 or the rolling element cage 5.

A plastic injection molding process is used to produce the outer bearing ring 2 and/or the inner bearing ring 3 and/or the rolling bearing cage 5, which is described below in more detail. According to a modification, the outer bearing ring 2 and/or the inner bearing ring 3 and/or the rolling bearing cage 5 are produced by a 3D printing process. Such a method will also be discussed below.

A second exemplary embodiment of a bearing 1 is shown schematically in FIGS. 2 and 3. This bearing 1 also has an outer bearing ring 2 and an inner bearing ring 3, both of which are made of plastic. Any rolling elements or a rolling element cage are not shown in these representations for the sake of clarity. In this bearing 1, a functional module 10 is arranged entirely within the outer bearing ring 2. The functional module 10 is completely enclosed by the material of the outer bearing ring 2 and does not protrude beyond the outer contour of the outer bearing ring 2, so that the bearing 1 can replace a conventional bearing without a functional module 10 without requiring additional mounting space. The functional module 10 can comprise, for example, a sensor for determining the temperature or vibrations.

To manufacture the bearing 1 described above, at least the outer bearing ring 2 is made as a first bearing component of plastic. A functional module 10 is arranged such that it is completely enclosed within the outer bearing ring 2. The inner bearing ring 3 is also made of plastic.

According to a first variant of this manufacturing process, the outer bearing ring 2 is produced by a plastic injection molding process. An injection mold, which is adapted to the shape of the outer bearing ring 2, is provided, into which a plastic is injected to form the outer bearing ring 2. Before or during the injection, one or more functional modules 10 are additionally introduced into the injection mold, so that the functional module or modules 10 are overmolded. The outer bearing ring 2 obtained in this way is hardened and can be reworked after removal from the injection mold, for example by grinding or polishing the surfaces. The inner bearing ring 3 and/or the rolling element cage 5 can also be produced by a corresponding plastic injection molding process. One or more additional function modules 10 or a measurement object 11 can optionally be introduced into the respective bearing components 3, 5.

A second variant of the production method provides that the outer bearing ring 2 is produced by a 3D printing process, the functional module or functions 10 being introduced into the outer bearing ring 2 when it is printed. For example, a first area of the outer bearing ring 2 can first be printed and a functional module 10 can be applied to the first area. In the subsequent printing, the functional module 10 can then be enclosed by a second area of the outer bearing ring 2 and/or the second area can be printed on the functional module 10.

With the methods described above, a bearing 1 can be produced with a functional module 10, which does not enlarge the mounting space required for the bearing 1 and can be produced with reduced effort, whereby protection against undesired damage to the functional module 10 is improved.

### LIST OF REFERENCE NUMBERS

1 rolling bearing
2 outer bearing ring
3 inner bearing ring
4 rolling elements
5 rolling element cage
6 sealing element
10 function module
11 counterpart

1. A bearing comprising: a first bearing component, in particular a bearing ring or a rolling element cage, and a function module for detecting a measured variable and/or for activating state changes and/or for processing information and/or for providing energy,
wherein
the functional module is arranged completely enclosed within the first bearing component.

2. The bearing according to claim 1, further comprising a second bearing component and a measuring object interacting with the functional module or a further functional module is arranged completely enclosed within the second bearing component.

3. The bearing according to claim 1, wherein the first bearing component is made of plastic and is produced by a plastic injection molding process.

4. The bearing according to claim 1, wherein the first bearing component is produced by a 3D printing process.

5. A method for producing a bearing with a first bearing component, in particular a bearing ring or a rolling element cage, and a function module for detecting a measured variable and/or for activating state changes and/or for processing information and/or for providing energy,
the method comprising
completely enclosing the functional module within the first bearing component.

6. The method according to claim 5, wherein the bearing has a second bearing component and a measuring object interacting with the function module or a further function module, the method further comprising completely enclosing the measuring object or further function module within the second bearing component.

7. The method according to claim 5, further comprising producing the first bearing component by a plastic injection molding process.

8. The method according to claim 7, wherein the functional module is overmolded.

9. The method according to claim 5, further comprising producing the first bearing component by a 3D printing process.

10. The method according to claim 9, wherein the first bearing component is printed on or around the functional module.

11. A bearing comprising:
a first ring;
a second ring supported for rotation relative to the first ring; and
a function module completely enclosed within the first ring.

12. The bearing of claim 11 further comprising a plurality of roller radially between the first ring and the second ring.

13. The bearing of claim 12 further comprising a cage circumferentially separating the rollers of the plurality of roller from one another.

14. The bearing of claim 11 further comprising a measuring object interacting with the function module and completely enclosed in the second ring.

15. The bearing of claim 11 further comprising a second function module completely enclosed in the second ring.

16. The bearing of claim 11 wherein the first ring and the second ring are plastic.
